(19) United States
(12) Patent Application Publication
(10) Pub. No.: US 2005/0159907 A1
(43) Pub. Date: Jul. 21, 2005

(54) Method and apparatus for VLSI clock gated power estimation using LCB counts

(75) Inventors: Rajat Chaudhry, Austin, TX (US); Brian King Flachs, Georgetown, TX (US); Daniel Lawrence Stasiak, Rochester, MN (US)

Correspondence Address: Gregory W. Carr;670 Founders Square, 900 Jackson Street, Dallas, TX, 75202, US

(73) Assignee: International Business Machines Corporation, Armonk, NY (US)

(21) Appl. No.: 10/759,936

(22) Filed: Jan. 16, 2004

(51) Int. Cl. G06F 19/00

(52) U.S. Cl. 702/60

(57) ABSTRACT

A method, an apparatus, and a computer program are provided for modeling algorithm for power consumption with improved accuracy. The improved model allows for variable operation of Local Clock Buffers (LCBs), which consume significant amounts power. Also, the amount of power consumed by each LCB can be varied. These variations of operation of LCBs and power consumption by LCBs allows for a more realistic model of operation of a given circuit or macro instead of the traditional “worst-case scenario” of power consumption.

### BACKGROUND OF THE INVENTION

1. Field of the Invention

The present invention relates generally to the computer modeling of Very Large-Scale Integration (VLSI) and, more particularly, to more accurately predicting power consumption with computer models.

2. Description of the Related Art

In VLSI design, power consumption is a significant factor. Battery life, heat produced, packaging, and so forth can be adversely affected by power consumption. Hence, low power chips are desirable.

Estimation of power consumption begins with breaking a chip into smaller analytic components. The smaller analytic components are known as macros, which are essentially smaller block portions of a larger circuit. For example, a macro can be a latch, a raised cosine filter, or a variety of other pluralities of components. Examining smaller components of a chip allow for convenience in modeling. There are also a variety of simulator software packages that can be used to construct circuits, for example Simulated Program for Integrated Circuits Emphasis (SPICE).

Typically, once the chip has been broken down into macros, an energy model for each macro can be developed based on the input pins. The power consumption is based on several factors, such as clock activity, switching of the input pins, and so forth. In convention modeling algorithms, the clocks are assumed to be “ON” all of the time or one hundred percent clock activity. Estimations based on one hundred percent clock activity yield an overall maximum of power consumption. The input pins, on the other hand, have associated switching factors. The switching factors typically range from zero to fifty percent or no switch to one-half of the pins are switching.

By making assumptions that clock activity is at one hundred percent, the power consumption model is in accurate. When the physical components are actually operating, there are period in which the clock activity may vary. Hence, the power consumption model with one hundred percent clock activity does yield an overall maximum, but does not precisely model the activity of a given macro under “real world” conditions.

Therefore, there is a need for a method and/or apparatus for modeling algorithm for power consumption with improved accuracy that addresses at least some of the problems associated with conventional methods and apparatuses for modeling power consumption.

### SUMMARY OF THE INVENTION

The present invention provides for approximating power consumption of a circuit with a plurality of local clock buffers (LCBs). A Hardware Descriptive Language (HDL) simulator data of the circuit is input. Net capacitance data of the circuit is input. Energy model data is input, wherein the energy model data further comprises extrapolating energy data by increasing or decreasing the number of active LCBs. Power consumption data is generated from the HDL simulator data, the net capacitance data, and the energy model data.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a macro;

FIG. 2 is a block diagram depicting power table;

FIG. 3 is a flow chart depicting the operation power consumption modeler;

FIG. 4 is a block diagram depicting a macro with varying internal power consumptions;

FIG. 5 is a macro with LCBs that consume varying amounts of power; and

FIG. 6 is a flow chart depicting the operation power consumption algorithm for a macro with varying internal power consumptions.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combinations thereof. In a preferred embodiment, however, the functions are performed by a processor such as a computer or an electronic data processor in accordance with code such as computer program code, software, and/or integrated circuits that are coded to perform such functions, unless indicated otherwise.

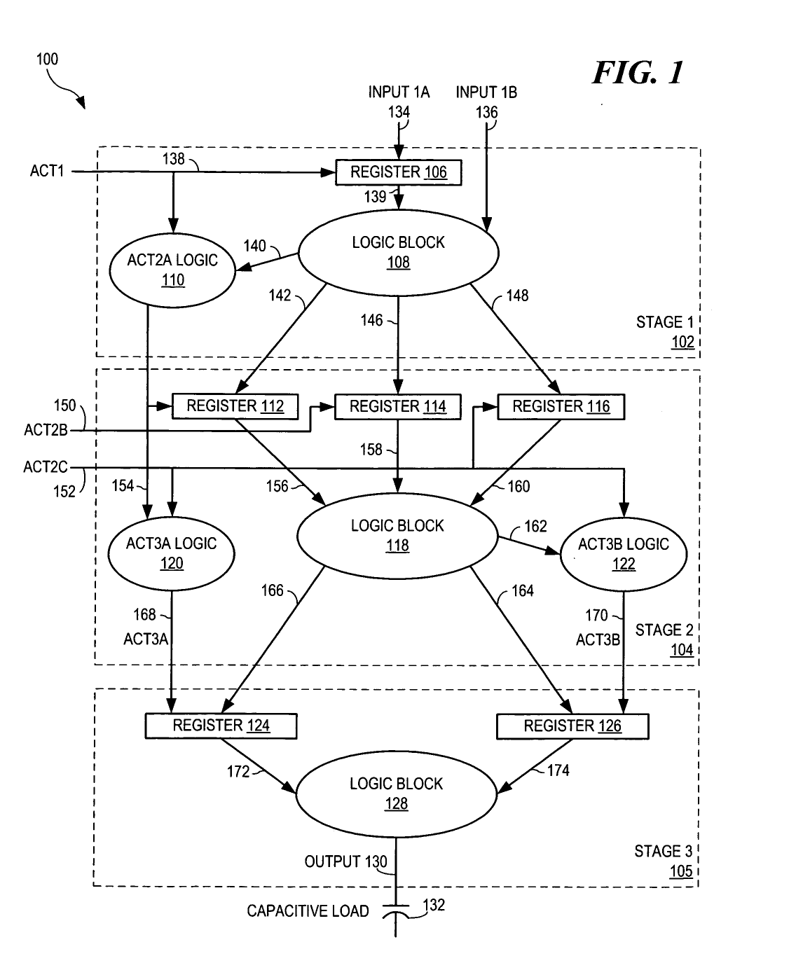

Referring to FIG. 1 of the drawings, the reference numeral 100 generally designates a macro. The macro 100 comprises a first stage 102, a second stage 104, and a third stage 105. The first stage 102 comprises a first register 106, a first logic block 108, and ACT2a Logic 110. The second stage 104 comprises a second register 112, a third register 114, a fourth register 116, a second logic block 118, ACT3a Logic 120, and ACT3b Logic 122. The third stage 105 comprises a fifth register 124, a sixth register 126, and a third logic block 128. The macro 100, the first stage 102, the second stage 104, and the third stage 105 can perform a variety of tasks normally performed by logic circuitry.

For the macro 100 to function, a plurality of signals should be input into the macro 100. A first input signal (Input 1a) is input into the first register 106 through a first communication channel 134. A second input signal (Input 1b) is input to the first logic block 108 through a second communication channel 136. A first activation signal (ACT1) is input into the first register 106 and the ACT2a logic 110 through a third communication channel 138. A second activation signal (ACT2a) is communicated from the ACT2a logic 110 to the second register 112 and the ACT3a logic through a fourth communication channel 154. A third activation signal (ACT2b) is input into the third register 114 through a fifth communication channel 150. A fourth activation signal (ACT2c) is input into the ACT3a Logic 120, the fourth register 116, and the ACT3b logic 122 through a fifth communication channel 152. A fifth activation signal (ACT3a) is communicated to the fifth register 124 through a sixth communication channel 168. A sixth activation signal (ACT3b) is communicated to the sixth register 126 through a seventh communication channel 170. Within each register there exists a Local Clock Buffer (LCB) (not shown) that receives the respective activation signal.

Also, in order for the macro 100 to function, there are a number of internal connections. The first register 106 is coupled to the first logic block 108 through an eighth communication channel 139. The first logic block 108 is coupled to the second register 112 through a ninth communication channel 142, to the third register 114 through a tenth communication channel 146, to the fourth register 116 through an eleventh communication channel 148, and to the ACT2a logic 110 through a twelfth communication channel 140. The second register 112 is coupled to the second logic 118 through a thirteenth communication channel 156. The third register 114 is coupled to the second logic block 118 through a fourteenth communication channel 158. The fourth register 116 is coupled to the second logic block 118 through a fifteenth communication channel 160. The second logic block 118 is further coupled to the fifth register 124 through a sixteenth communication channel 166, to the sixth register 126 through a seventeenth communication channel 164, and to the ACT3b logic 122 through an eighteenth communication channel 162. The ACT3b logic 122 is also coupled to the sixth register 126 through a nineteenth communication channel 170. Also, the ACT3a logic 120 is coupled to the fifth register 124 through a twentieth communication channel 168. The fifth register 124 is further coupled to the third logic block 128 through a twenty-first communication channel 172. The sixth register 126 is further coupled to the third logic block 128 through a twenty-second communication channel 174. The third logic block then outputs an output signal (OUTPUT) to a capacitive load 132 through a twenty-third communication channel 130.

Based on the signals input into the macro 100 at the various stages, the power consumption can be determined. In conventional modeling methods, there is one hundred percent clock signal activation while input signal rates are varied. In other words, all of the activation signals are active or “ON,” and the input signals are varied. By maintaining one hundred percent clock signal activation, an absolute maximum of power consumption can be determined, but a realistic power consumption model is unattainable.

An improved method is to vary the activation of the activation of the clock signals to attain a more realistic model. To calculate power consumption, a formula is necessary and is as follows:
Macro Power=(PAR100−PAR0)*(LCBA/LCBT)+PAR0. (1)
PAR100 corresponds to the power consumption with one hundred percent clock activation, which is essentially the value calculated in conventional modeling methods. PAR0 is the power consumption with no clock activation. LCBA are the number of LCBs that are utilized as a result of the number of active clock signals. LCBT is the total number of LCBs.

FIG. 1 can be used as an example for determining a more realistic power consumption of the macro 100. It is assumed for the purpose of illustration that 1.5 Watts are consumed for one hundred percent activation (PAR100=1.5 W) and that 0.5 Watts are consumed for zero percent activation (PAR0=0.5 W). Also, it is assumed for the purposes of illustration that the second activation signal (ACT2a), the third activation signal (ACT2b), and the fourth activation signal (ACT2c) are all active while the first activation signal (ACT1), the fifth activation signal (ACT3a), and the sixth activation signal (ACT3b) are all gated. If there is one LCB for each register, then the total number of LCBs is 6 (LCBT=6), and the active number of LCBs is 3 (LCBA=3). Therefore, the calculation would be as follows:
Macro Power=(1.5 W-0.5 W)*(3/6)+0.5 W=1 W (2)
Hence, the improved power consumption model yields a power consumption that reflects the activation of a fraction of the total number of active clock signals. In contrast, if a convention power consumption method is utilized, the power consumed is assumed to be 1.5 Watts.

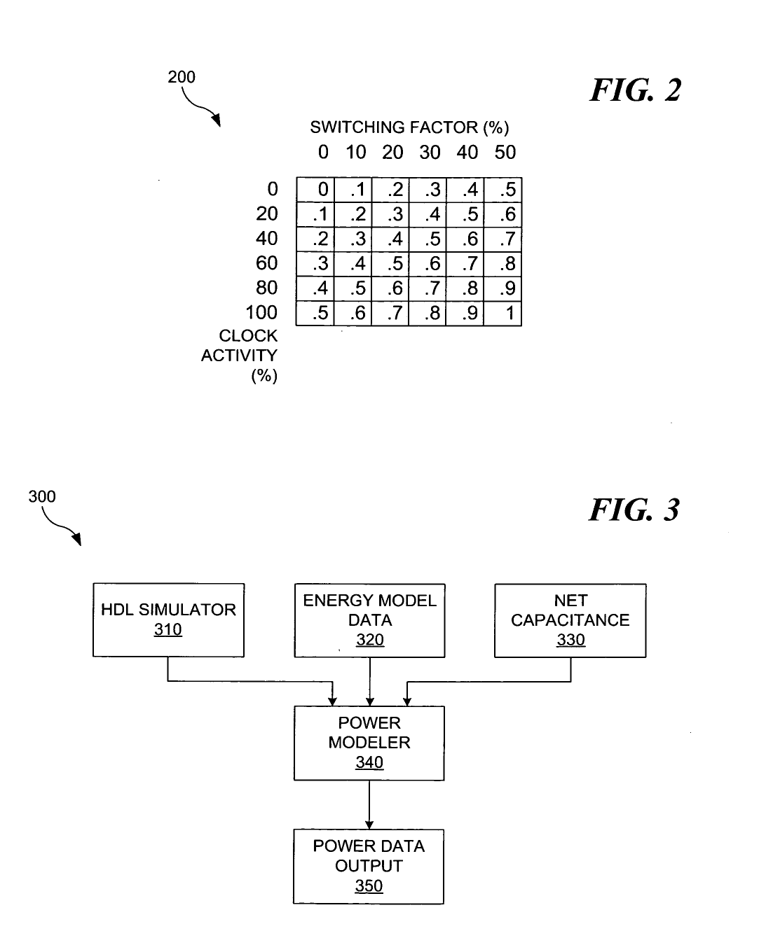

Referring to FIG. 2 of the drawings, the reference numeral 200 generally designates a power table. The vertical axis denotes percentage of clock activity. The horizontal axis denotes the switching factor, which is a percentage of input activity that range from zero to fifty percent. From the improved power consumption model, four data point are calculated for zero percent clock activity-zero percent switching factor, zero percent clock activity-fifty percent switching factor, one hundred percent clock activity-zero percent switching factor, and one hundred percent clock activity-fifty percent switching factor. From these four data points, the remaining values of the table are linearly extrapolated.

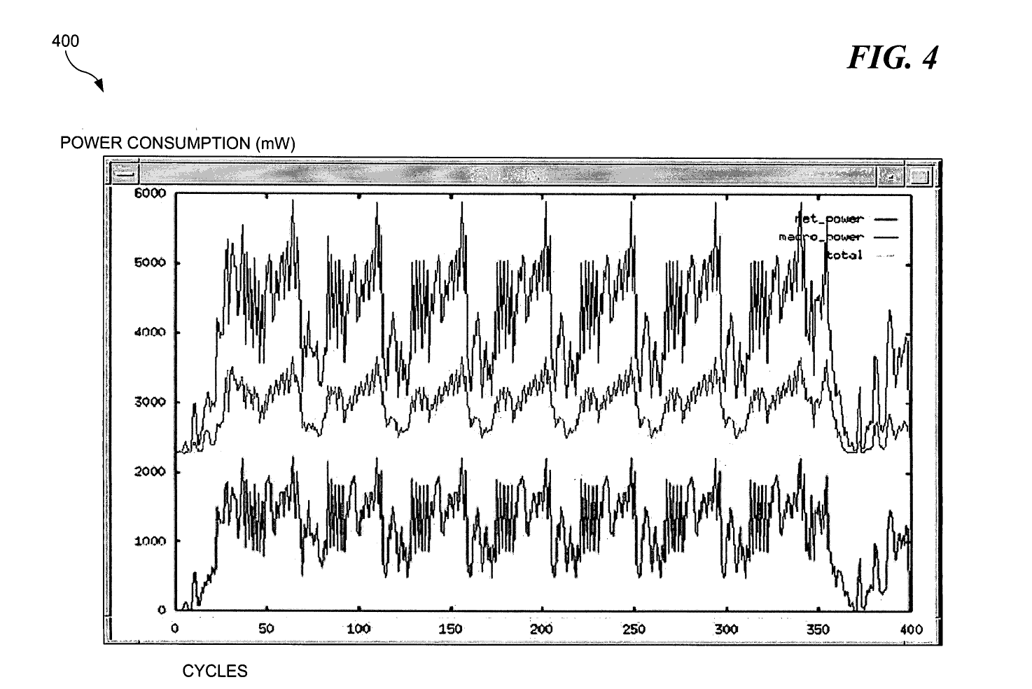

Referring to FIG. 3 of the drawings, the reference numeral 300 depicts a flow chart of the operation of a power consumption modeler. A Hardware Descriptive Language (HDL) simulation 310, the energy model data 320 (generated in FIG. 2), and the macro net capacitance 330 are input into the power modeler 340. The power modeler 340 can then generate an operational model of the power consumption as the macro operates as a Power Data Output 350. FIG. 4 is an example of an operational model of the power consumption of a given macro.

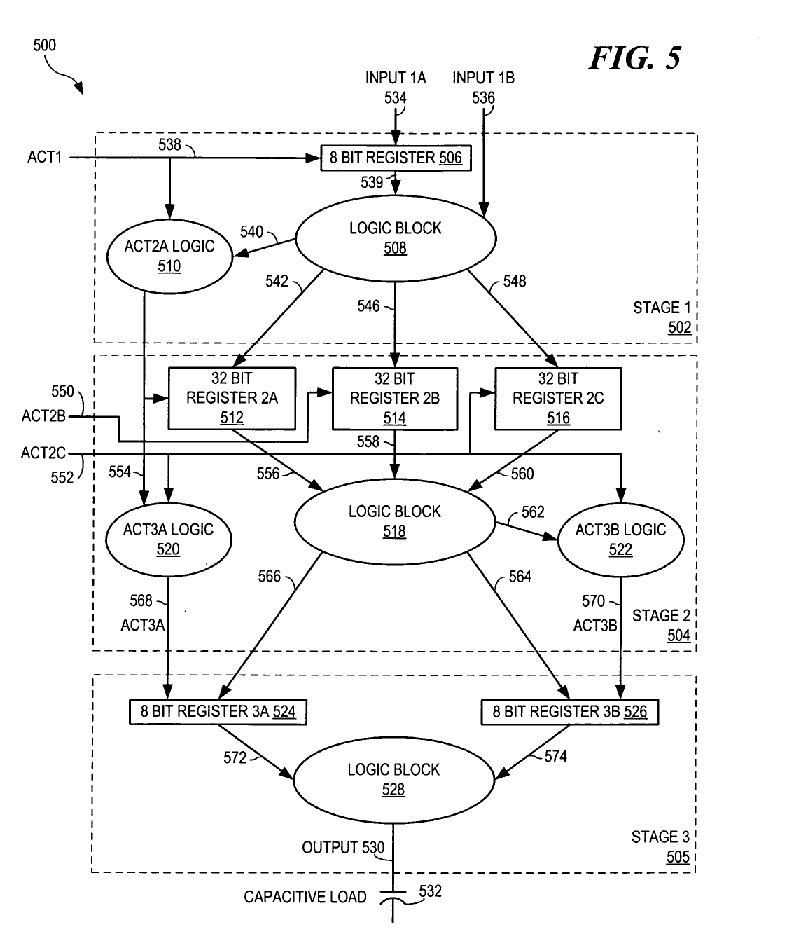

Referring to FIG. 5 of the drawings, the reference numeral 500 generally designates a macro with LCBs that consume varying amounts of power. The macro 500 comprises a first stage 502, a second stage 504, and a third stage 505. The first stage 502 comprises a first 8-bit register 506, a first logic block 508, and ACT2a Logic 510. The second stage 504 comprises a first 32-bit register 512, a second 32-bit register 514, a third 32-bit register 516, a second logic block 518, ACT3a Logic 520, and ACT3b Logic 522. The third stage 505 comprises a second 8-bit register 524, a third 8-bit register 526, and a third logic block 528. The macro 500, the first stage 502, the second stage 504, and the third stage 505 can perform a variety of tasks normally performed by logic circuitry.

For the macro 500 to function, a plurality of signals should be input into the macro 500. A first input signal (Input 1a) is input into the first 8-bit register 506 through a first communication channel 534. A second input signal (Input 1b) is input to the first logic block 508 through a second communication channel 536. A first activation signal (ACT1) is input into the first 8-bit register 506 and the ACT2a logic 510 through a third communication channel 538. A second activation signal (ACT2a) is communicated from the ACT2a logic 510 to the first 32-bit register 512 and the ACT3a logic through a fourth communication channel 554. A third activation signal (ACT2b) is input into the second 32-bit register 514 through a fifth communication channel 550. A fourth activation signal (ACT2c) is input into the ACT3a Logic 520, the third 32-bit register 516, and the ACT3b logic 522 through a fifth communication channel 552. A fifth activation signal (ACT3a) is communicated to the second 8-bit register 524 through a sixth communication channel 568. A sixth activation signal (ACT3b) is communicated to the third 8-bit register 526 through a seventh communication channel 570. Within each register there exists a Local Clock Buffer (LCB) (not shown) that receives the respective activation signal.

Also, in order for the macro 500 to function, there are a number of internal connections. The first 8-bit register 506 is coupled to the first logic block 508 through an eighth communication channel 539. The first logic block 508 is coupled to the first 32-bit register 512 through a ninth communication channel 542, to the second 32-bit register 514 through a tenth communication channel 546, to the third 32-bit register 516 through an eleventh communication channel 548, and to the ACT2a logic 510 through a twelfth communication channel 540. The first 32-bit register 512 is coupled to the second logic 518 through a thirteenth communication channel 556. The second 32-bit register 514 is coupled to the second logic block 518 through a fourteenth communication channel 558. The third 32-bit register 516 is coupled to the second logic block 518 through a fifteenth communication channel 560. The second logic block 518 is further coupled to the second 8-bit register 524 through a sixteenth communication channel 566, to the third 8-bit register 526 through a seventeenth communication channel 564, and to the ACT3b logic 522 through an eighteenth communication channel 562. The ACT3b logic 522 is also coupled to the third 8-bit register 526 through a nineteenth communication channel 570. Also, the ACT3a logic 520 is coupled to the second 8-bit register 524 through a twentieth communication channel 568. The second 8-bit register 524 is further coupled to the third logic block 528 through a twenty-first communication channel 572. The third 8-bit register 526 is further coupled to the third logic block 528 through a twenty-second communication channel 574. The third logic block then outputs an output signal (OUTPUT) to a capacitive load 532 through a twenty-third communication channel 530.

Based on the signals input into the macro 500 at the various stages, the power consumption can be determined. In conventional modeling methods, there is one hundred percent clock signal activation while input signal rates are varied. In other words, all of the activation signals are active or “ON,” and the input signals are varied. By maintaining one hundred percent clock signal activation, an absolute maximum of power consumption can be determined, but a realistic power consumption model is unattainable.

Another improved method is to vary the activation of the activation of the clock signals to attain a more realistic model and the power consumption for each LCB. To calculate power consumption, a formula is necessary and is as follows:

$$\begin{matrix}Macro Power = ( PAR100 - PAR0 ) * ( {\sum }_{n = 1}^{LCBT} {W}_{n} ( x ) * {LCB}_{n} ) + PAR0 , \\ where & ( 1 ) \\ {\sum }_{n = 1}^{LCBT} {W}_{n} ( x ) = 1 & ( 2 )\end{matrix}$$

PAR100 corresponds to the power consumption with one hundred percent clock activation, which is essentially the value calculated in conventional modeling methods. PAR0 is the power consumption with no clock activation. Wₙ(x) are the weighted values of the corresponding power consumption of respective LCBs that are utilized. LCBₙ is a 0 or 1 corresponding to whether the respective LCB is active or gated. Also, LCBT is the total number of LCBs.

FIG. 5 can be used as an example for determining a more realistic power consumption of the macro 500. It is assumed for the purpose of illustration that 1.5 Watts are consumed for one hundred percent activation (PAR100=1.5 W) and that 0.5 Watts are consumed for zero percent activation (PAR0=0.5 W). Also, it is assumed for the purposes of illustration that the second activation signal (ACT2a), the third activation signal (ACT2b), and the fourth activation signal (ACT2c) are all active while the first activation signal (ACT1), the fifth activation signal (ACT3a), and the sixth activation signal (ACT3b) are all gated. If there is one LCB for each register, then the total number of LCBs is 6 (LCBT=6). If it is further assumed that the total power consumed by each LCB is directly proportional to the number of bits in the register, then the three LCBs associated with the three 8-bit registers would consume 0.1/15 of the total power for one hundred percent clock activity, and the three LCBs associated with three 32-bit registers would consume 4/15of the total power for one hundred percent clock activity. There are also a variety of other factors that can contribute to power consumption, such as the transistor types used. Therefore, the calculation would be as follows:

$$\begin{matrix}Macro Power = ( 1.5 W - 0.5 W ) * ( 3 * ( 0 * 1 / 15 ) + \\ 3 * ( 4 / 15 ) ) + 0.5 W \\ = ( 1 W ) * ( 4 / 5 ) + 0.5 W = 1.3 W\end{matrix} \qquad ( 2 )$$

Hence, the improved power consumption model yields a power consumption that reflects the activation of a fraction of the total number of active clock signals with power consumptions proportional to actual power consumptions. In contrast, if a convention power consumption method is utilized, the power consumed is assumed to be 1.5 Watts.

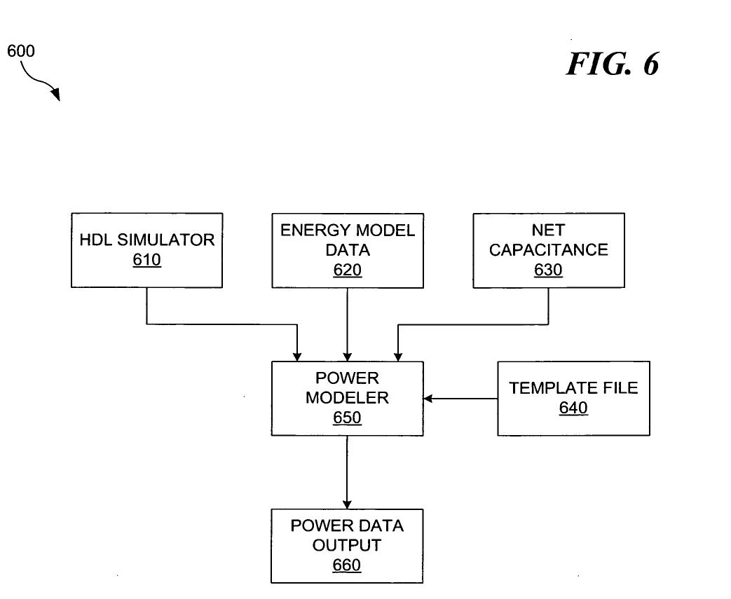

Referring to FIG. 6 of the drawings, the reference numeral 600 depicts a flow chart of the operation of a power consumption modeler. A HDL simulation 610, the energy model data 620, the net capacitance 630, and the template file 640 that describes the amount that each LCB consumes are input into the power modeler 650. The power modeler 650 can then generate an operational model of the power consumption as the macro operate as a Power Data Output 360. FIG. 4 is an example of an operational model of the power consumption of a given macro.

It will further be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. A method for approximating power consumption of a circuit with a plurality of local clock buffers (LCBs), comprising:
inputting a Hardware Descriptive Language (HDL) simulator data of the circuit;
inputting net capacitance data of the circuit;
inputting energy model data, wherein the energy model data further comprises extrapolating energy data by increasing or decreasing the number of active LCBs; and
generating power consumption data from the HDL simulator data, the net capacitance data, and the energy model data.

2. The method of claim 1, wherein each LCB of the plurality of LCBs is at least configured to consume the same amount of power.

3. The method of claim 2, wherein the energy model data further comprises extrapolating energy data by increasing or decreasing numbers of active input signals to the circuit.

4. The method of claim 1, wherein the method further comprises inputting template data, wherein the template data is at least configured to contain relative power consumption data for each LCB of the plurality of LCBs.

5. The method of claim 4, wherein the relative power consumption data of each LCB of the plurality of LCBs are at least configured to be the same or different.

6. The method of claim 5, wherein each LCB of the plurality of LCBs is at least configured to consume the same amount of power.

7. The method of claim 6, wherein the energy model data further comprises extrapolating energy data by increasing or decreasing numbers of active input signals to the circuit.

8. The method of claim 7, wherein the generating power consumption data is at least configured to utilize the template data.

9. An apparatus for approximating power consumption of a circuit with a plurality of local clock buffers (LCBs), comprising:
means for inputting HDL simulator data of the circuit;
means for inputting net capacitance data of the circuit;
means for inputting energy model data, wherein the energy model data further comprises extrapolating energy data by increasing or decreasing the number of active LCBs; and
means for generating power consumption data from the HDL simulator data, the net capacitance data, and the energy model data.

10. The apparatus of claim 9, wherein each LCB of the plurality of LCBs is at least configured to consume the same amount of power.

11. The apparatus of claim 10, wherein the energy model data further comprises means for extrapolating energy data by increasing or decreasing numbers of active input signals to the circuit.

12. The apparatus of claim 9, wherein the method further comprises means for inputting template data, wherein the template data is at least configured to contain relative power consumption data for each LCB of the plurality of LCBs.

13. The apparatus of claim 12, wherein the relative power consumption data of each LCB of the plurality of LCBs are at least configured to be the same or different.

14. The method of claim 13, wherein each LCB of the plurality of LCBs is at least configured to consume the same amount of power.

15. The method of claim 14, wherein the energy model data further comprises means for extrapolating energy data by increasing or decreasing numbers of active input signals to the circuit.

16. The method of claim 15, wherein the means for generating power consumption data is at least configured to utilize the template data.

17. A computer program product for approximating power consumption of a circuit with a plurality of local clock buffers (LCBs), the computer program product having a medium with a computer program embodied thereon, the computer program comprising:
computer code for inputting HDL simulator data of the circuit;
computer code for inputting net capacitance data of the circuit;
computer code for inputting energy model data, wherein the energy model data further comprises extrapolating energy data by increasing or decreasing the number of active LCBs; and
computer code for generating power consumption data from the HDL simulator data, the net capacitance data, and the energy model data.

18. The computer program product of claim 17, wherein each LCB of the plurality of LCBs is at least configured to consume the same amount of power.

19. The computer program product of claim 18, wherein the energy model data further comprises computer code for extrapolating energy data by increasing or decreasing numbers of active input signals to the circuit.

20. The computer program product of claim 17, wherein the method further comprises computer code for inputting template data, wherein the template data is at least configured to contain relative power consumption data for each LCB of the plurality of LCBs.

21. The computer program product of claim 20, wherein the relative power consumption data of each LCB of the plurality of LCBs are at least configured to be the same or different.

22. The computer program product of claim 21, wherein each LCB of the plurality of LCBs is at least configured to consume the same amount of power.

23. The computer program product of claim 22, wherein the energy model data further comprises computer code for extrapolating energy data by increasing or decreasing numbers of active input signals to the circuit.

24. The computer program product of claim 23, wherein the generating power consumption data is at least configured to utilize the template data.
